(19) United States
(12) Patent Application Publication
(10) Pub. No.: US 2011/0012799 A1
(43) Pub. Date: Jan. 20, 2011

(54) GLASS ANTENNA AND WINDOW GLASS FOR VEHICLE

(75) Inventor: Koichi SAITO, Tokyo (JP)

Correspondence Address: FOLEY AND LARDNER LLP;SUITE 500, 3000 K STREET NW, WASHINGTON, DC, 20007, US

(73) Assignee: Asahi Glass Company, Limited

(21) Appl. No.: 12/835,583

(22) Filed: Jul. 13, 2010

(30) Foreign Application Priority Data
Jul. 14, 2009 (JP) 2009-165939

(51) Int. Cl. H01Q 1/32

(52) U.S. Cl. 343/713

(57) ABSTRACT

A glass antenna for a vehicle, includes: a feed part; and an antenna conductor includes: a first element including a first terminating portion which extends in an upward or downward direction and constitutes a termination of extension of the first element in a first direction and a second terminating portion which constitutes a termination of extension of the first element in a second direction; a second element extending in a third direction which is at right angles to the upward or downward direction; the third element extending in a fourth direction which is an opposite direction to the third direction; the fourth element extending in the second direction; the fifth element extends in the second direction; and the connection element extending around an element end in the second direction of the fourth element to connect the feed part with the second terminating portion.

### BACKGROUND

1. Field of the Invention

The present invention relates to a glass antenna for a vehicle in which an antenna conductor and a feed part connected to the antenna conductor are provided on a window glass. In addition, the invention relates to a window glass for a vehicle which includes the glass antenna.

2. Description of the Related Art

Frequency bands where specific radio waves such as radio waves for frequency-modulation or FM broadcasting are available vary destination by destination of vehicles to be shipped. Therefore, as is described in JP-A-9-172315, JP-A-62-38001 and JP-A-62-38002, there have been demands for glass antennas for a vehicle which can be used commonly in both Japan and other countries (for example, the United States of America).

A glass antenna described in JP-A-9-172315 is designed to attain a broad band by attaching a matching circuit and the like in addition to antenna elements.

In contrast to this, glass antennas described in JP-A-62-38001 and JP-A-62-38002 realize a broad band by antenna elements only.

With the glass antenna described in JP-A-9-172315, however, attaching the various components in addition to the antenna elements is not desired due to an increase in production costs and necessity of securing more installation space for the added components.

With the glass antennas described in JP-A-62-36001 and JP-A-62-38002, the glass antenna has to be enlarged in size to realize the broad band by the antenna elements only. In the event of a glass antenna being installed on a backlite, an increase in installation area of the glass antenna means a decrease in installation area of a backlite defogging system, leading to a problem that the defogging area is narrowed. Further, a further increase in gain has been demanded as the size of glass antennas tends to be decreased.

### SUMMARY

An object of the invention is to provide a small and high-gain glass antenna for a vehicle in which no matching circuit is required, and which can commonly be used in Japan and other countries and a window glass equipped with the glass antenna.

According to an aspect of the invention, there is provided a A glass antenna provided with a window glass for a vehicle, including: a feed part; and an antenna conductor including a first element, a second element, a third element, a fourth element, a fifth element and a connection element, wherein: the feed part is positioned to either a left-hand side or a right-hand side of the first element; the first element extends in an upward or downward direction in a case that the window glass is attached to the vehicle and includes a first terminating portion which constitutes a termination of extension of the first element in a first direction which is either of the upward and downward directions and a second terminating portion which constitutes a termination of extension of the first element in a second direction which is an opposite direction to the first direction; the second element extends from the first terminating portion in a third direction which is at right angles to the upward or downward direction and which is directed towards a side where the feed part is situated relative to the first element; the third element extends from the first terminating portion in a fourth direction which is an opposite direction to the third direction; the fourth element extends from the second element in the second direction; the fifth element extends from the third element in the second direction; the connection element extends to go around an element end in the second direction of the fourth element on a side in the second direction so as to connect the feed part with the second terminating portion; and at least either of the fourth element and the fifth element includes a folded portion which extends to fold in the second direction.

According to another aspect of the invention, there is provided a window glass for a vehicle, including the glass antenna.

According to the invention, the glass antenna in which no matching circuit is required which can commonly be used in Japan and other countries while decreasing the size and increasing the antenna gain.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a plan view of a glass antenna for a vehicle according to one aspect of the invention;

FIG. 2 is a plan view of a glass antenna for a vehicle according to another aspect of the invention;

FIG. 3 is a plan view of a glass antenna for a vehicle according to still another aspect of the invention;

FIG. 4 is a plan view of a glass antenna for a vehicle according to still another aspect of the invention;

FIG. 5 is a plan view of a glass antenna for a vehicle according to still another aspect of the invention;

FIG. 6 is a plan view of a glass antenna for a vehicle according to still another aspect of the invention;

FIG. 7 is a plan view of a glass antenna for a vehicle according to still another aspect of the invention;

FIG. 8 is a plan view of a glass antenna for a vehicle according to still another aspect of the invention;

FIG. 9 is a plan view of a window glass on which the glass antenna and a defogger are provided;

FIGS. 10A and 10B are plan views of glass antennas for a vehicle which are compared with the glass antennas;

FIG. 11 is a frequency characteristic chart showing antenna gains of glass antennas which are different in distance between A and F;

FIG. 12 is a frequency characteristic chart showing antenna gains of the glass antennas;

FIG. 13 is a frequency characteristic chart showing antenna gains of glass antennas which are substantially equal to each other in distance between A and B and distance between A and C.

FIG. 14 is a frequency characteristic chart showing antenna gains of glass antennas which are equal to each other in distance between B and D and distance between C and E.

FIG. 15 is a frequency characteristic chart showing antenna gains of the glass antennas; and

FIG. 16 is a chart showing actually measured data of antenna gains for each band when an overlapping distance xsl is changed by adjusting a length between H and C of the glass antenna.

### DETAILED DESCRIPTION OF THE INVENTION

Hereinafter, a mode for carrying out the invention will be described by reference to the drawings. Note that in the drawings which illustrate the mode, in referring to directions, directions on the drawings will be referred to as long as nothing is stated otherwise. In addition, the drawings show glass antennas or the like fitted to a window glass attached to a vehicle in such a state that the window glass is viewed from the interior of the vehicle. However, those drawings may be referred to as drawings showing the window glass as viewed from the outside of the vehicle. For example, in the event of the window glass being a backlite which is attached to the rear of the vehicle, a left-right or horizontal direction on the drawings corresponds to a vehicle width direction. In addition, the invention is not limited to the backlite and hence may be applied to a windshield which is attached to a front part of the vehicle or a side window glass which is attached to a side part of the vehicle.

In addition, glass antennas according to the invention may be disposed or arranged vertically opposite to what is shown on the drawings to illustrate them. Namely, the glass antennas may be fitted on the window glass in a vertically opposite orientation to those shown on the drawings when a plane of the window glass is looked squarely.

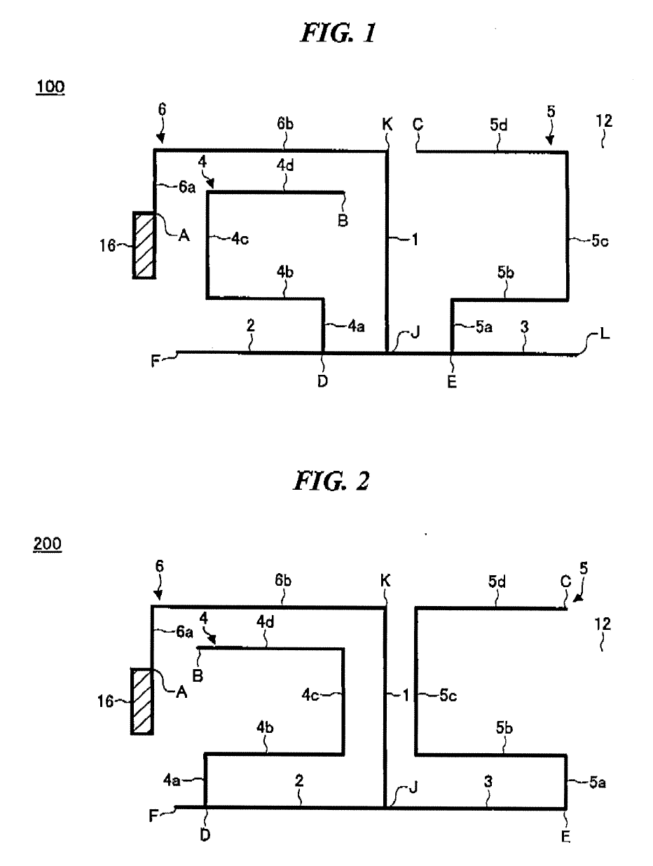

FIG. 1 is a plan view of a glass antenna 100 for a vehicle, according to the invention. The glass antenna 100 is an antenna in which an antenna conductor and a feed part 16 which is connected to the antenna conductor are provided on a window glass 12 in a planar fashion. The glass antenna 100 includes, as its antenna conductor pattern, an antenna element 1 which is a first element, an antenna element 2 which is a second element, an antenna element 3 which is a third element, an antenna element 4 which is a fourth element, an antenna element 5 which is a fifth element and a connection element 6 which connects the feed part 16 and the antenna element 1 together. The feed part 16 is positioned either to the left or to the right of the antenna element 1. In the embodiment shown in FIG. 1, the feed part 16 is positioned to the left of the antenna element 1.

With the plane of the window glass 12 looked squarely, the antenna element 1 extends in a vertical direction when the window glass 12 is attached to the vehicle. The antenna element includes a first terminating portion J and a second terminating portion K. The first terminating portion J constitutes a termination of extension of the antenna element 1 in a first direction which denotes either of upward and downward directions, and in the case of the embodiment shown in FIG. 1, the first terminating portion J constitutes a termination of extension of the antenna element 1 in a downward direction. The second terminating portion K constitutes a termination of extension of the antenna element 1 in a second direction which is an opposite direction to the first direction, and in the case of the embodiment shown in FIG. 1, the second terminating portion K constitutes a termination of extension of the antenna element 1 in an upward direction.

With the plane of the window glass 12 looked squarely, the antenna element 2 extends in a third direction which is a direction which is at right angles to the vertical direction when the window glass 12 is attached to the vehicle and which is directed towards a side where the feed part 16 is situated relative to the antenna element 1 (that is, a leftward direction on the drawing). The antenna element 2 extends from the terminating portion J as its origin to a terminating portion F which constitutes a termination of extension of the antenna element 2 in the leftward direction.

With the plane of the window glass 12 looked squarely, the antenna element 3 extends in a fourth direction which is an opposite direction to the third direction (that is, a rightward direction on the drawing). The antenna element 3 extends from the terminating portion J as its origin to a terminating portion L which constitutes a termination of extension of the antenna element 3 in the rightward direction.

The antenna element 4 extends from a point D on the antenna element 2 as its origin to a terminating portion B which constitutes a termination of extension of the antenna element 4 in the upward direction. The antenna element 4 may extend in the upward direction from the terminating portion F as its origin. The antenna element 4 shown in FIG. 1 includes a first winding or folded portion where the antenna element 4 extends to wind or fold in the upward direction.

The antenna element 4 includes a partial element 9a which extends in the upward direction from the point D as its origin, as well as a partial element 4b which extends in the leftward direction from a terminating portion of extension of the partial element 4a as its origin, a partial element 4c which extends in the upward direction from a terminating portion of extension of the partial element 4b as its origin and a partial element 4d which extends in the rightward direction from a terminating portion of extension of the partial element 4c as its origin to the terminating portion E. The partial element 4b, the partial element 4c and the partial element 4d constitute a first folded portion.

The antenna element 5 extends from a point E on the antenna element 3 as its origin to a terminating portion C which constitutes a termination of extension of the antenna element 5 in the upward direction. The antenna element 5 may extend in the upward direction from the terminating portion L as its origin. The antenna element 5 includes a second folded portion where the antenna element 5 extends to fold in the upward direction.

The antenna element 5 includes a partial element 5a which extends in the upward direction from the point E as its origin, as well as a partial element 5b which extends in the rightward direction from a terminating portion of extension of the partial element 5a as its origin, a partial element 5c which extends in the upward direction from a terminating portion of extension of the partial element 5b as its origin and a partial element 5d which extends in the leftward direction from a terminating portion of extension of the partial element 5c as its origin to the terminating portion C. The partial element 5b, the partial element 5c and the partial element 5d constitutes a second folded portion.

In the case of FIG. 1, the folded portion of the antenna element 4 includes a first opening portion which is opened at a right-hand side and is closed at a left-hand side thereof. The folded portion of the antenna element 5 includes a second opening portion which is opened at a left-hand side and is closed at a right-hand side. The first opening portion and the second opening portion constitute portions which are made to open towards the antenna element 1. Orientations in which the first opening portion and the second opening portion are opened are opposite on a straight line which is imaginarily drawn at right angles to the direction in which the antenna element 1 extends.

The “opening portion” is such as to be provided between a distal end portion of one of the partial elements lying adjacent vertically of the plurality of partial elements which constitute the folded portion and a distal end portion of the other partial element. In the case of FIG. 1, one opening portion is formed between one terminating portion of the partial element 4b and one terminating portion of the partial element 4d so as to be opened to the right towards the antenna element 1. Similarly, one opening portion is formed between one terminating portion of the partial element 5b and one terminating portion of the partial element 5d so as to be opened to the left towards the antenna element 1.

In addition, in a case that a combination of a leftward outgoing fold and rightward incoming fold is considered as one time of fold, the folded portion may include one or more times of fold depending upon an antenna gain required. In addition, the folded portion may be provided only on either of the partial element 4 and the partial element 5 depending upon an antenna gain required.

The connection element 6 extends to go around an end of the upper partial element of the antenna element 4 (in the case of FIG. 1, the partial element 4d) thereabove so as to connect the feed part 16 and the terminating portion K together. The connection element 6 includes a partial element 6a which is connected to the feed part 16 and which extends in the upward direction and a partial element 6b which is connected to the partial element 6a at one end portion and is connected to the antenna element 1 at the other end portion and which extends in the left-right direction.

Here, the “terminating portion” may be a terminating point of extension of the antenna elements or a point in proximity to the terminating point which constitutes a conductor portion lying just before the terminating point.

The feed part 16 and the antenna conductor are formed by printing a paste such as a silver paste which contains a conductive metal on an inner surface side of a windowpane and baking the paste so printed. However, the invention is not limited to this forming method. Hence, linear elements or foil elements made of a conductive substance such as copper may be formed on an inner surface side or an outer surface side of a window glass may be affixed to the window glass with an adhesive or the like or may be embedded in an interior of the window glass itself.

The glass antenna 100 is a monople antenna. A reception signal of radio wave received by the antenna conductor is transmitted to a signal processing circuit mounted in a vehicle via a conductive member which is electrically connected to the feed part 16 which corresponds to a feeding point. A feeding cable such as an AV wire or a coaxial cable is used as the conductive member. In the event of a coaxial cable being used, an inner conductor of the coaxial cable is electrically connected to the feed part 16 and an outer conductor of the coaxial cable is grounded to a vehicle body.

In addition, a configuration may be adopted in which a terminal is mounted on the feed part 16 for electrically connecting the feed part 16 with the conductive member such as a conductor wire which is connected to the signal processing circuit. The feeding cable can easily be attached to the feed part 16 by use of the terminal. Further, a configuration may also be adopted in which a projecting conductive member is provided on the feed part 16, so that the projecting conductive member is brought into contact with or fitted on a flange of the vehicle body to which the window glass 12 is attached.

The configuration of the feed part 16 may be determined in accordance with the configuration of a mounting surface of the conductive member or a connector. For example, a quadrangular shape such as a square, substantially square, rectangular or substantially rectangular shape or a polygonal shape is preferred in consideration of ease of mounting. In addition, a circular, substantially circular, oval or substantially oval shape may also be adopted.

FIG. 2 is a plan view of a glass antenna 200 for a vehicle, according to the invention. The description of similar portions to those of the glass antenna described above will be omitted from the following description.

In the case of FIG. 2, a folded portion of an antenna element 4 includes a first opening portion having a portion which is opened at a left-hand side and is closed at a right-hand side thereof. A folded portion of an antenna element 5 includes a second opening portion having a portion which is opened at a right-hand side and is closed at a left-hand side thereof. The first opening portions and the second opening portion are the portions which are made to open in directions which move away from an antenna element 1. The first opening portion and the second opening portion are opened in opposite directions on an imaginary straight line which is at right angles to a direction in which the antenna element 1 extends.

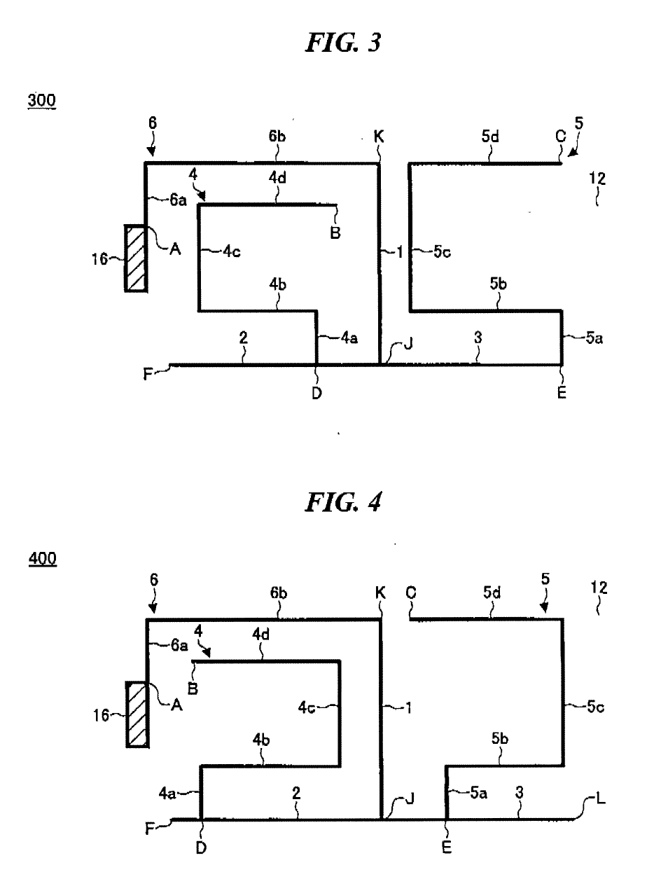

FIG. 3 is a plan view of a glass antenna 300 for a vehicle, according to the invention. The description of similar portions to those of the glass antenna described above will be omitted from the following description.

In the case of FIG. 3, a folded portion of an antenna element 9 includes a first opening portion having a portion which is opened at a right-hand side and is closed at a left-hand side thereof. A folded portion of an antenna element 5 includes a second opening portion having a portion which is opened at a right-hand side and is closed at a left-hand side thereof. The first opening portion is the portion which is opened towards an antenna element 1, and the second opening portion is the portion which is opened in a direction which moves away from the antenna element 1. The first opening portion and the second opening portion are opened in the same direction on an imaginary straight line which is at right angles to a direction in which the antenna element 1 extends.

FIG. 4 is a plan view of a glass antenna 400 for a vehicle, according to the invention. The description of similar portions to those of the glass antenna described above will be omitted from the following description.

In the case of FIG. 4e a folded portion of an antenna element 4 includes a first opening portion having a portion which is opened at a left-hand side and is closed at a right-hand side thereof. A folded portion of an antenna element 5 includes a second opening portion having a portion which is opened at a right-hand side and is closed at a left-hand side thereof. The first opening portion is the portion which is opened in a direction which moves away from an antenna element 1, and the second opening portion is the portion which is opened towards the antenna element 1. The first opening portion and the second opening portion are opened in the same direction on an imaginary straight line which is at right angles to a direction in which the antenna element 1 extends.

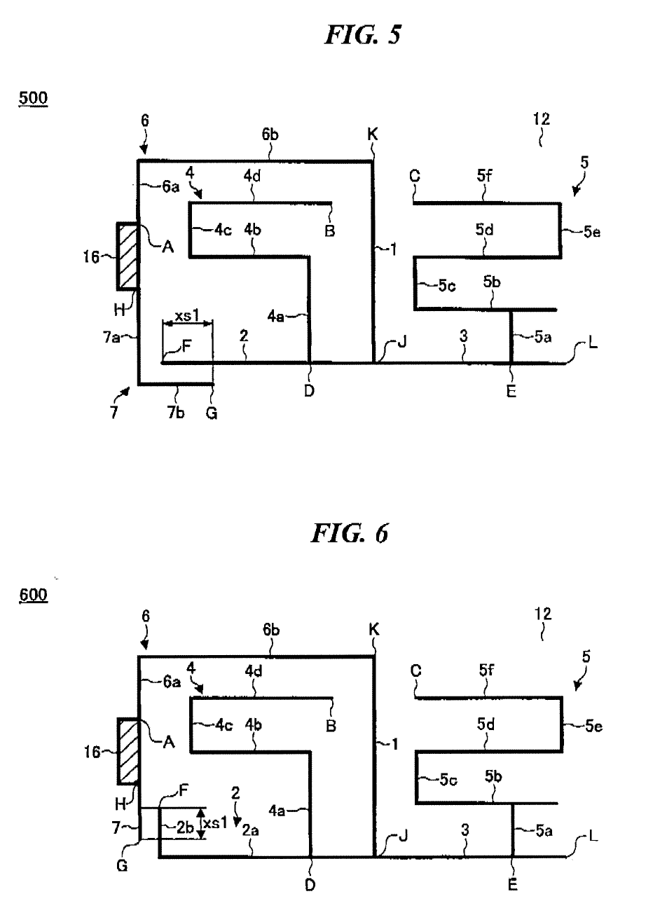

FIG. 5 is a plan view of a glass antenna 500 for a vehicle, according to the invention. The description of similar portions to those of the glass antenna described above will be omitted from the following description.

In the case of FIG. 5, a folded portion of an antenna element 4 includes a first opening portion having a portion which is opened at a right-hand side and is closed at a left-hand side thereof. A folded portion of an antenna element 5 includes a second opening portion having a first-stage portion which is opened at a right-hand side and is closed at a left-hand side thereof and a second-stage portion which is opened at a left-hand side and is closed at a right-hand side thereof. The first opening portion and the second-stage opening portion of the second opening portion are opened in the same direction on an imaginary straight line which is at right angles to a direction in which the antenna element 1 extends.

In addition, an extension element 7 is an element which constitutes part of the antenna conductor and extends from the feed part 16 as its origin. The extension element 7 extends from a lower end point H as its origin to a terminating portion G. The extension element 7 includes a parallel extending portion which extends parallel to the antenna element 2 while keeping a gap which enables the antenna element 2 and the extension element 7 to be joined together in terms of capacity. By doing so, the characteristics (including impedance) can be controlled, so as to increase the antenna gain.

In the case of FIG. 5, the extension element 7 includes a partial element 7a which extends in a downward direction from the feed part 16 as its origin and a partial element 7b which extends in a rightward direction from a terminating portion as its origin which constitutes a termination of extension of the partial element 7a in the downward direction. The extension element 7 includes the parallel extending portion which extends parallel to the antenna element 2 below the antenna element 2 on the partial element 7b. Namely, the parallel extending portion runs in the left-right direction so as to be parallel to the antenna element 2 which lies adjacent thereto in the vertical direction. A conductor length xsl of the parallel extending portion is a length of a portion where the antenna element 2 and the extension element 7 overlap when the antenna element 2 is projected downwards on the extension element 7.

Being different from the case shown in FIG. 5, the extension element 7 may extend parallel to the antenna element 2 above the antenna element 2.

FIG. 6 is a plan view of a glass antenna 600 for a vehicle, according to the invention. The description of similar portions to those of the glass antenna described above will be omitted.

An antenna element 2 includes a partial element 2a which extends in a leftward direction from a terminating portion J as its origin and a partial element 2b which extends in an upward direction from a terminating portion of extension of the partial element 2a in the leftward direction as its origin to a terminating portion F.

An extension element 7 includes a parallel extending portion which extends parallel to the partial element 2b of the antenna element 2 on a left-hand side of the antenna element 2. Namely, the parallel extending portion runs vertically parallel to the partial element 2b of the antenna element 2 which lies adjacent thereto in the left-right direction. A conductor length sxl of the parallel extending portion is a length of a portion where the partial element 2b and the extension element 7 overlap when the partial element 2b is projected leftwards on the extension element 7.

Being different from the case shown in FIG. 6, the extension element 7 may extend parallel to the antenna element 2 on a right-hand side of the antenna element 2.

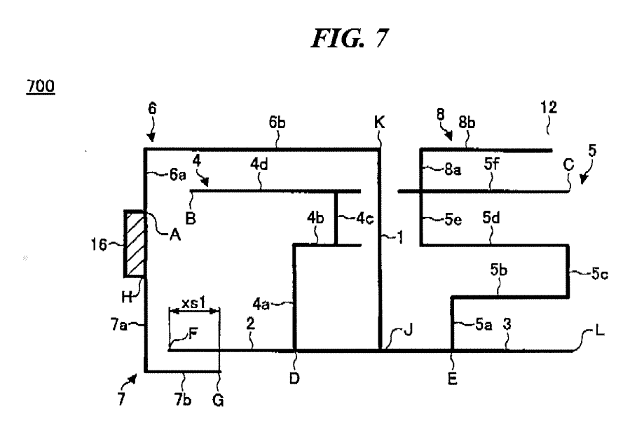

FIG. 7 is a plan view of a glass antenna 700 for a vehicle, according to the invention. The description of similar portions to those of the glass antenna described above will be omitted.

In the case of FIG. 7, a folded portion of an antenna element 4 includes a first opening portion having a portion which is opened at a left-hand side and is closed at a right-hand side thereof. A folded portion of an antenna element 5 includes a second opening portion having a first-stage portion which is opened at a left-hand side and is closed at a right-hand side thereof and a second-stage portion which is opened at a right-hand side and is closed at a left-hand side thereof. The first opening portion and the second-stage portion of the second opening portion are opened in opposite directions on an imaginary straight ling which is at right angles to a direction in which an antenna element 1 extends.

In addition, a partial element 4b and a partial element 4d may not be connected to a partial element 4c at respective terminating portions but may be connected thereto at portions lying in proximity to the respective terminating portions. In addition, an auxiliary antenna element 8 is connected to the antenna element 5 as part of an antenna conductor. The antenna element 8 includes a partial element 8a which extends in an upward direction from a partial element 5f as its origin and a partial element 8b which extends in a rightward direction from a terminating portion of extension of the partial element 8a as its origin. The antenna gain can be tuned by the antenna element so added.

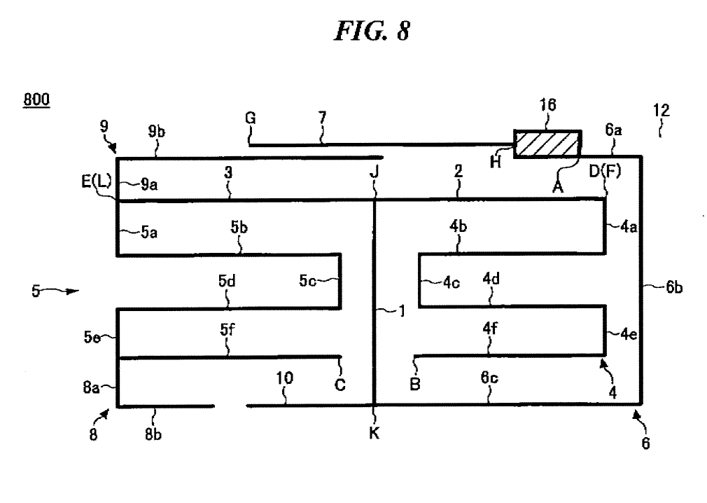

FIG. 8 is a plan view of a glass antenna 800 for a vehicle, according to the invention. The description of similar portions to those of the glass antenna described above will be omitted.

A feed part 16 is positioned to either of sides of an antenna element 1 in the left-right direction. In the case of an embodiment shown in FIG. 8, the feed part 16 is positioned to the right of the antenna element 1. Further, in the case of FIG. 8, the feed part 16 is positioned at an upper portion on a window glass 12 when the window glass 12 is attached to the vehicle.

In the case of FIG. 8 in which the feed part 16 is positioned at the upper portion of the window glass 12 when the window glass 12 is attached to the vehicle, in the event that a feeding end on the vehicle side is disposed at an upper edge portion of a flange of a vehicle body to which the window glass is attached, the feed part 16 and the feeding end on the vehicle side can be connected to each other with ease when the window glass is attached to the vehicle body. In contrast to this, in the case of FIGS. 1 to 7 in which the feed part 16 is positioned at the left-hand side or right-hand side portion of the window glass when the window glass 12 is attached to the vehicle, in the event that the feeding end on the vehicle side is disposed at a left-hand side or right-hand side edge portion of the flange of the vehicle body to which the window glass is attached, the feed part 16 and the feeding end on the vehicle side can be connected to each other with ease when the window glass is attached to the vehicle body.

With the plane of the window glass 12 looked squarely, the antenna element 1 extends in the vertical direction when the window glass 12 is attached to the vehicle. The antenna element 1 includes a first terminating portion J and a second terminating portion K. The first terminating portion J constitutes a termination of extension of the antenna element 1 in a first direction which denotes either of upward and downward directions, and in the case of the embodiment shown in FIG. 1, the first terminating portion J constitutes a termination of extension of the antenna element 1 in the upward direction. The second terminating portion K constitutes a termination of extension of the antenna element 1 in a second direction which is an opposite direction to the first direction, and in the case of the embodiment shown in FIG. 1, the second terminating portion K constitutes a termination of extension of the antenna element 1 in the downward direction.

With the plane of the window glass 12 looked squarely, an antenna element 2 extends in a third direction which is a direction which is at right angles to the vertical direction when the window glass 12 is attached to the vehicle and which is directed towards a side where the feed part 16 is situated relative to the antenna element 1 (that is a rightward direction on the drawing). The antenna element 2 extends from the terminating portion J as its origin to a terminating portion F which constitutes a termination of extension of the antenna element 2 in the rightward direction.

With the plane of the window glass 12 looked squarely, an antenna element 3 extends in a fourth direction which is an opposite direction to the third direction (that is, a leftward direction on the drawing). The antenna element 3 extends from the terminating portion J as its origin to a terminating portion L which constitutes a termination of extension of the antenna element 3 in the leftward direction.

An antenna element 4 extends from a point D on the antenna element 2 as its origin to a terminating portion B which constitutes a termination of extension of the antenna element 4 in the downward direction. In the case of FIG. 8, the antenna element 4 extends in the downward direction from the terminating portion F as its origin which constitutes a termination of extension of the second antenna element 2 in the rightward direction. The antenna element 4 shown in FIG. 8 includes a first winding or folded portion where the antenna element 4 extends to wind or fold in the downward direction.

The antenna element 4 includes a partial element 4a which extends in the downward direction from the point D as its origin, as well as a partial element 4b which extends in the leftward direction from a terminating portion of extension of the partial element 4a as its origin, a partial element 9c which extends in the downward direction from a terminating portion of extension of the partial element 4b as its origin, a partial element 4d which extends in the rightward direction from a terminating portion of extension of the partial element 4c as its origin, a partial element 4e which extends in the downward direction from a terminating portion of extension of the partial element 4d as its origin and a partial element 4f which extends in the leftward direction from a terminating portion of extension of the partial element 4e as its origin to the terminating portion B. The partial element 4b, the partial element 4c, the partial element 4d, the partial element 4e and the partial element 4f constitute a first folded portion.

An antenna element 5 extends from a point E on the antenna element 3 as its origin to a terminating portion C which constitutes a termination of extension of the antenna element in the downward direction. In the case of FIG. 8, the antenna element 5 extends in the downward direction from the terminating portion L of extension of the antenna element 3 in the left-hand side as its origin. The antenna element 5 includes a second folded portion where the antenna element 5 extends to fold in the downward direction.

The antenna element 5 includes a partial element 5a which extends in the downward direction from the point E as its origin, as well as a partial element 5b which extends in the rightward direction from a terminating portion of extension of the partial element 5a as its origin, a partial element 5c which extends in the downward direction from a terminating portion of extension of the partial element 5b as its origin, a partial element 5d which extends in the leftward direction from a terminating portion of extension of the partial element 5c as its origin, a partial element 5e which extends in the downward direction from a terminating portion of extension of the partial element 5d as its origin, and a partial element 5f which extends in the rightward direction from a terminating portion of extension of the partial element 5e as its origin to the terminating portion C. The partial element 5b, the partial element 5c, the partial element 5d, the partial element 5e and the partial element 5f constitutes a second folded portion.

In the case of FIG. 8, the folded portion of the antenna element 4 includes a first opening portion having a first-stage portion which is opened at a right-hand side and is closed at a left-hand side thereof and a second-stage portion which is opened at a left-hand side and is closed at a right-hand side thereof. The folded portion of the antenna element 5 includes a second opening portion having a first-stage portion which is opened at a left-hand side and is closed at a right-hand side thereof and a second-stage portion which is opened at a right-hand side and is closed at a left-hand side thereof. Orientations in which the first-stage portion of the first opening portion and the first-stage portion of the second opening portion are opened are opposite on a straight line which is imaginarily drawn at right angles to the direction in which the antenna element 1 extends. Orientations in which the second-stage portion of the first opening portion and the second-stage of the second opening portion are opened are 2D opposite on the straight line.

A connection element 6 extends to go around an end of the lower partial element of the antenna element 4 (in the case of FIG. 8, the partial element 4f) therebelow so as to connect the feed part 16 and the terminating portion K together. The connection element 6 includes a partial element 6a which is connected to the feed part 16 and which extends in the left-right direction and a partial element 6b which is connected to the partial element 6a at one end portion and is connected to the antenna element 1 at the other end portion and which extends in an L-shape.

An extension element 7 extends in the leftward direction from a left-hand side end point H of the feed part 16 as its origin to a terminating portion G. The extension element 7 includes a parallel extending portion which extends parallel to the antenna element 2 above the antenna element 2. Further, the parallel extending portion may be allowed to extend as far as the antenna element 3 as is shown in FIG. 8. In addition, the parallel running portion may extend parallel to an auxiliary element 9 which is connected to the antenna element 2 or the antenna element 3 (in the case of FIG. 8, to the antenna element 3) and which extends parallel to the antenna element 2 or the antenna element 3.

In the case of FIG. 8, the extension element 7 includes the parallel extending portion which extends parallel to the auxiliary antenna element 9 while keeping a gap which enables the auxiliary antenna element 9 and the extension element 7 to be joined together in terms of capacity. By doing so, the impedance of a leading end portion (a terminating portion) of the auxiliary antenna element 9 can be decreased.

An auxiliary element 8 is connected to the antenna element 5 as part of an antenna conductor. The antenna element 8 includes a partial antenna element 8a which extends in the downward direction from the partial antenna element 5f of the antenna element 5 as its origin and a partial element 8b which extends in the rightward direction from a terminating portion of extension of the partial element 8a as its origin. The antenna gain can be tuned by the antenna elements so added.

The auxiliary antenna element 9 is connected to the antenna element 3 as part of the antenna conductor. The antenna element 9 includes a partial element 9a which extends in the upward direction from the antenna element 3 as its origin and a partial element 9b which extends in the rightward direction from a terminating portion of extension of the partial element 9a as its origin. The antenna gain can be tuned by the antenna elements so added.

An auxiliary antenna element 10 is connected to the terminating portion as part of the antenna conductor. The antenna element 10 extends in the leftward direction from the terminating portion K as its origin so that a gap is formed between the element B and itself.

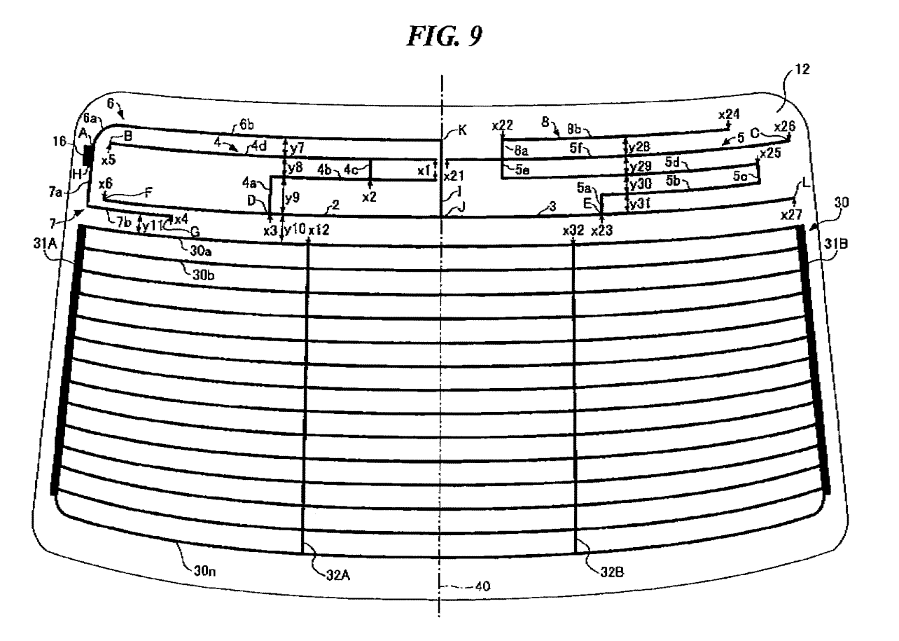

FIG. 9 is a plan view of a window glass 12 on which the glass antenna 700 and a defogger 30 are provided. The glass antennas illustrated in FIGS. 1 to 8 are preferably provided so as to lie adjacent to the defogger 30 in the vertical direction as is shown in FIG. 9 from the viewpoint of increasing the antenna gain. The antenna element 2 and the antenna element 3 extend parallel to an outermost heater wire of a plurality of parallel heater wires of the defogger 30 provided on the window glass 12. In the case of FIG. 9, the antenna elements 2, 3 extend parallel to an uppermost heater wire 30a.

In FIG. 9, dimensions of respective portions of the antenna element 700 may be referred to as below for example. x1: 10 mm; x2: 110 mm; x3: 260 mm; x4: 400 mm; x5: 500 mm; x6: 515 mm; y7: 27 mm; y8: 30 mm; y9: 60 mm; y10: 40 mm; y11: 30 mm; x12: 200 mm; x21: 10 mm; x22: 150 mm; x23: 250 mm; x24: 450 mm; x25: 500 mm; x26: 520 mm; x27: 535 mm; y28: 27 mm; y29: 30 mm; y30: 30 mm; y31: 30 mm; x32: 200 mm.

“x**” denotes a shortest distance from a point where the “x**” is indicated by an arrow in FIG. 9 to a center line 40 of the defogger 30 (or the window glass 12) in a direction in which the heater wires extend parallel to each other. The center line 40 is an imaginary line drawn in the vertical direction. In addition, “y**” denotes a shortest distance between the conductors in the vertical direction.

The defogger 30 is a pattern which is energized to be heated, and the pattern has a plurality of parallel heater wires (in FIG. 9, 14 heater wires 30a to 30n are illustrated) and a plurality of strip-like bus bars (in FIG. 9, two bus bars 31A, 31B are illustrated) which feed the heater wires. The plurality of heater wires are disposed on the window glass 12 so as to extend side by side in a direction parallel to a horizontal plane (a ground plane) in such a state that the window glass 12 is attached to the vehicle, for example. Two or more heater wires may be provided so as to extend parallel to each other. The plurality of heater wires which extend parallel to each other are short-circuited by short-circuit wires 32A, 32B. The short-circuit wires 32A, 32B affect the antenna gain, and the antenna gain can be tuned by the existence of the short-circuit wires 32A, 32B or lengths thereof. As to the bus bars 31A, 31B, in the case of FIG. 9, at least one bus bar 31A is provided in either of left- and right-hand side areas of the window glass 12 and at least one bus bar 31B is provided in the other side area. The bus bars so provided is caused to extend in a vertical or substantially vertical direction of the window glass 12.

Incidentally, in the glass antennas according to the invention which are illustrated in FIGS. 1 to 9, from the viewpoint of increasing the antenna gain in a desired broadcast frequency band to be received, good results can be obtained in the event that a length between A and B, a length between A and C, a length between B and D and a length between C and E are in the following ranges, respectively, assuming that a wavelength in the air of a central frequency of the desired broadcast frequency band is referred to as λ₀, a glass shortening coefficient of wavelength as k (where, k=0.64) and λ_{g} as λ_{g}=λ₀·k and in consideration of a glass antenna which includes a pattern in which antenna elements are branched:

Length between A and B: 0.65λ_{g} or larger and 1.20λ_{g} or smaller;

Length between A and C: 0.65λ_{g} or larger and 1.20λ_{g} or smaller;

Length between A and F: 0.5λ_{g} or larger and 0.9λ_{g} or smaller;

Length between B and D: 0.20λ_{g} or larger and 0.60λ_{g} or smaller; and

Length between C and E: 0.20λ_{g} or larger and 0.60λ_{g} or smaller.

The length between A and B is a longest conductor path length of conductor path which connect an upper end point A of the feed part 16 and the terminating point B of extension of the element 4 in a shortest way. The length between A and C is a longest conductor path length of conductor path which connect the upper end point A of the feed part 16 and the terminating point C of extension of the element 5 in a shortest way. The length between A and F is a longest conductor path length of conductor path which connect the upper end point A of the feed part 16 and the terminating point F of extension of the element 2 in a shortest way. The length between B and D is a longest conductor path length of conductor path which connect the end point B and the end point D in a shortest way. The length between C and E is a longest conductor path length of conductor path which connect the end point C and the end point E in a shortest way.

Here, the center frequency of the FM broadcast (76 to 90 MHz) in Japan is 98 MHz. λ_{g} of the central frequency 83 MHz is 2.313 m. On the other hand, the center frequency of the FM broadcast (88 to 108 MHz) in the United States of America is 98 MHz.

Consequently, for example, when an antenna gain for an FM broadcast band (76 to 108 MHz) which combines the Japanese FM band with the US FM band is attempted to be increased, since λ_{g} of its central frequency 92 MHz is 2.086 m, the length between A and B, the length between A and C, the length between B and D and the length between C and E may be controlled as below:

Length between A and B: 1355 mm or lager and 2500 mm or smaller;

Length between A and C: 1355 mm or larger and 2500 mm or smaller;

Length between A and F: 1043 mm or larger and 1877 mm or smaller;

Length between B and D: 417 mm or larger and 1251 mm or smaller; and

Length between C and E: 417 mm or larger and 1251 mm or

Further, when the antenna gain for the FM broadcast band (76 to 108 MHz) which combines the Japanese FM band with the CS FM band is attempted to be increased, it is good that a length between H and G is controlled as below:

Length between H and G; 40 mm or larger and 140 mm or smaller.

The length between H and G is a longest conductor path length of conductor path which connect the end point H and the end point G in a shortest way. A value resulting when 80 mm is subtracted from the length between H and G corresponds to the overlapping distance xsl.

In the glass antennas according to the invention, by increasing the area on the window glass occupied by antenna elements by adding the plurality antenna elements as antenna conductors, the antenna gain for radio waves in the AM band can also be increased.

In addition, in the invention, in the event that the glass antenna is disposed in a top left-hand side area of the window glass 12 in any of the forms shown in FIGS. 1 to 9, a glass antenna which takes a form which is transversely symmetrical with the glass antennas shown in FIGS. 1 to 8 may also be disposed in a top right-hand side area of the window glass 12. This will be true with a bottom area. In the event that the plurality of glass antennas are installed as described above, a diversity reception is enabled, and the reception characteristic is preferably increased.

In addition, a glass antenna may be adopted in which a conductor layer including antenna conductors is provided in an interior or on a surface of a synthetic resin film and the synthetic resin film with the conductor layer is formed on an interior surface or exterior surface of a windowpane. Further, a glass antenna may be adopted in which a flexible circuit board on which antenna conductors are formed is formed on an interior surface or exterior surface of a windowpane.

An angle at which the window glass is attached to the vehicle is preferably in the range of 15 to 90° and is more preferably in the range of 30 to 90°.

In addition, a concealing layer is be formed on a surface of the window glass, and part or the whole of the antenna conductors may be provided on the concealing layer. As a material for the concealing layer, ceramics including a black ceramic layer can be raised. In this case, when the glass antenna is looked at from an outer side of the window glass, the antenna conductors provided on the concealing layer are made invisible from the outside of the vehicle, resulting in a window glass which is superior in design. In the illustrated configurations, by at least part of the feed part and the antenna conductors being formed on the concealing layer, only thin straight portions of the antenna conductors are allowed to be seen from the outside of the vehicle, which is preferable from the viewpoint of design.

### EXAMPLES

As to a high-frequency glass antenna for a vehicle, which is fabricated by attaching any of the on-glass antennas shown in FIGS. 1 to 8 on an upper side of a backlite of an actual vehicle, results of actual measurements of frequency characteristics or the like will be described.

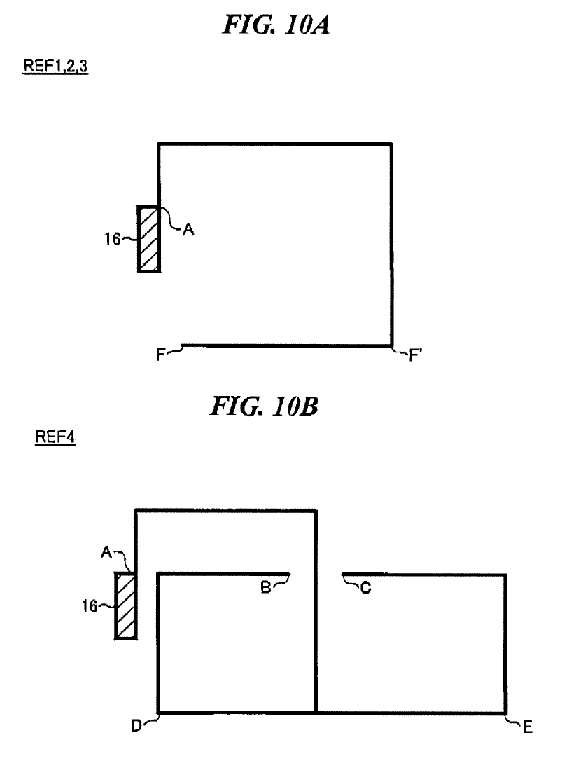

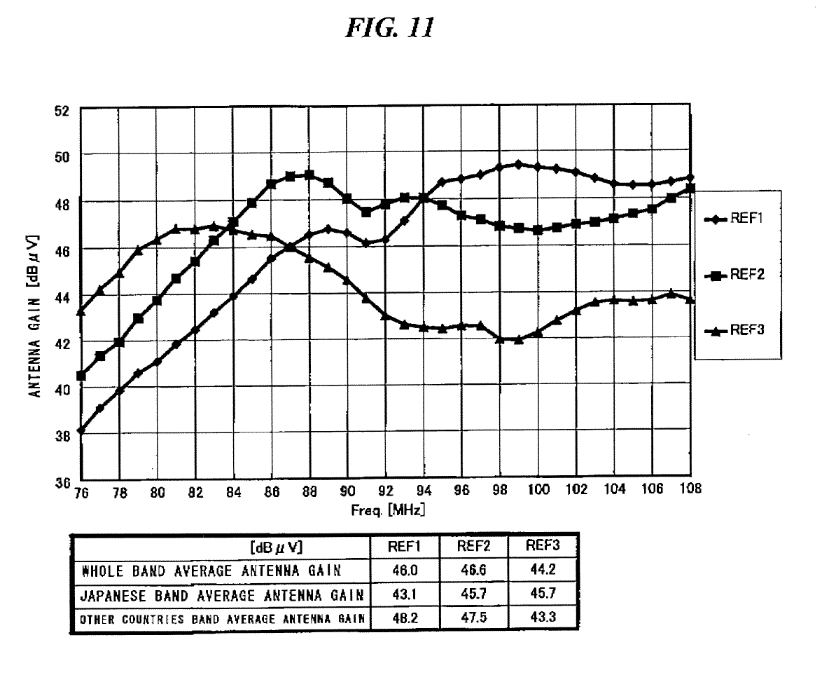

FIGS. 1 to 8 are the plan views of the glass antennas according to the invention, and FIGS. 10A and 10B show plan views of glass antennas REF1, 2, 3, 4 which are compared with the glass antennas 100 to 800. The glass antennas 100 to 80 are superior to the glass antennas REF1, 2, 3, 4 in reception of the FM broadcast band (76 to 108 MHz) which combines the Japanese FM broadcast band with the US FM broadcast band.

A conductor width of each element in the examples is 0.8 mm. In addition, the feed part 16 is 27 mm long in the vertical direction and 13 mm wide in the horizontal direction.

Antenna gains were measured on the glass antennas in such a state that an window glass for a vehicle on which the glass antenna was formed was assembled into a window frame of a vehicle on a turntable while being inclined at 14° relative to a horizontal plane. In the glass antennas, a connector is attached to the feed part and is connected to an amplifier. The amplifier is an amplifier having a gain of 8 dB. In addition, the amplifier is connected with a tuner by a feeder line (1.5 C-2V 9.5 m). The turntable is turned so that the window glass is exposed to radio waves (polarized waves whose frequency is in the range of 76 to 108 MHz and whose polarization plane is inclined at 45° from the horizontal plan) which strike horizontally the widow glass in every direction.

Antenna gains are measured by aligning a vehicle center of the motor vehicle into which the window glass on which the glass antenna is formed is assembled with a center of the turntable and rotating the motor vehicle through 360°. Data on antenna gains is measured every 1 MHz in the radiation frequency band of 76 to 108 MHz every time the turntable is turned through 1°. Measurements were carried out with an elevation angle between a transmission position of radio waves and the antenna conductors was substantially horizontal (in a direction in which the elevation angle=0° in the event of a plane parallel to the ground plane being referred to as elevation angle=0° and an apex direction being referred to as an elevation angle=90°.

In the following frequency characteristic charts of antenna gains, an antenna gain along an axis of ordinates indicates an average value of antenna gains which were measured every 1° by rotating the motor vehicle through 360° (an average value of antenna gains obtained every 1 MHz in the whole frequency band of 76 to 108 MHz).

FIG. 10A shows the glass antennas REF 1, 2, 3 which are compared with the invention, and the glass antennas REF 1, 2, 3 cannot be applied to the wide band such as the FM broadcast band which is the combination of the Japanese and US FM broadcast bands, which constitutes the object of the invention. In the invention, by adding the various antenna elements to the glass antennas REF 1, 2, 3, the glass antenna is realized which is small in size and which obtains the high antenna gain over the broad band.

FIG. 11 is a frequency characteristic chart of antenna gains of the glass antennas REF 1, 2, 3 which are different in the length between A and F from each other. An effect imposed on antenna gain by the length between A to F was studied. Dimensions of respective portions of the glass antennas REF 1, 2, 3 (FIG. 10A) when the antenna gains shown in FIG. 11 were measured were as below:

Length between A and F of REF 1: 1185 mm

Length between F and F′ of REF 1: 515 mm

Length between A and F of REF 2: 1385 mm

Length between F and F′ of REF 2: 615 mm

Length between A and F of REF 3: 1585 mm

Length between F and F′ of REF 3: 715 mm

According to FIG. 11, it is seen that although any of the antenna gains of the glass antennas REF 1, 2, 3 are low in the Japanese hand, the antenna gains increase largely in the other countries band when the length between A and F decrease. Namely, the antenna gains in the other countries band are determined in accordance with the length between A and F.

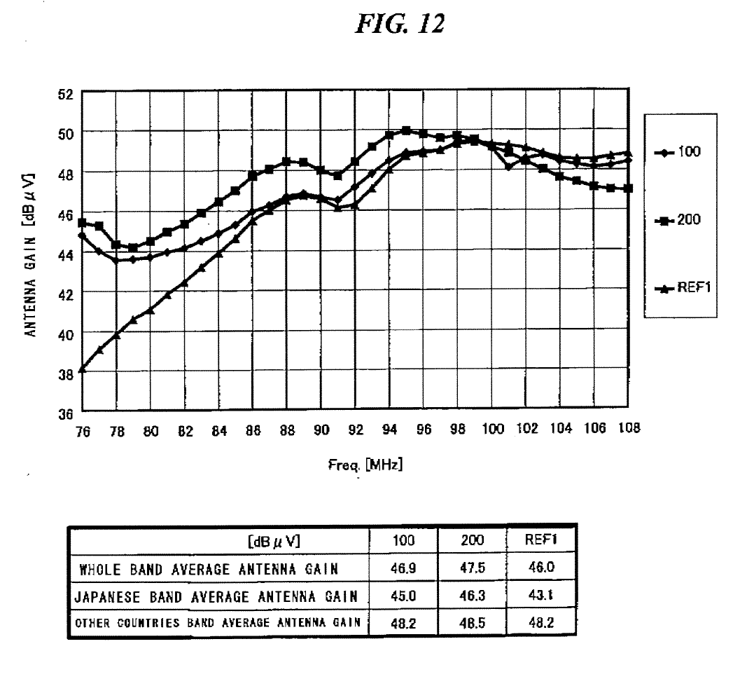

FIG. 12 is a frequency characteristic chart of antenna gains of the glass antennas 100, 200, REF 1 which are same in the length between A and F. Effects imposed on antenna gain by the length between A and B and the length between A and C were studied.

Dimensions of respective portions of the glass antenna 100 (FIG. 1) when the antenna gains shown in FIG. 12 were measured were as below:

Length between A and B: 1640 mm

Length between A and C: 1630 mm

Length between A and F: 1185 mm

Length between B and D: 900 mm

Length between C and E: 930 mm

Length between A and L: 1205 mm

Dimensions of respective portions of the glass antenna 200 (FIG. 2) when the antenna gains shown in FIG. 12 were measured were as below:

Length between A and B: 2040 mm

Length between A and C: 2080 mm

Length between A and F: 1185 mm

Length between B and D: 900 mm

Length between C and E: 930 mm

Dimensions of respective portions of the glass antenna REF 1 (FIG. 10A) when the antenna gains shown in FIG. 12 were measured were as below:

Length between A and F: 1185 mm

Length between F and F′: 515 mm

According to FIG. 12, when calculating average gains in the whole frequency band of 76 to 108 MHz, an average gain of the glass antenna 100 is 46.9 dBμV, and an average gain of the glass antenna REF 1 is 46.0 dBμV. Thus, with the glass antenna of the invention, the average antenna gain is secured which is equal to or larger than the average antenna gain of the conventional glass antenna in the whole frequency band. In addition, since the antenna gain in a low frequency area of the glass antenna 100 is increased compared with the glass antenna REF 1, the average gain of the glass antenna 100 in the Japanese band is increased compared with the glass antenna REF 1. In addition, with the glass antenna 100, the average gain equal to or larger than that of the conventional antenna is secured also in the US band.

In addition, according to FIG. 12, with the glass antenna 200 in which the opening portions of the folded portions formed on both the sides of the antenna element 1 are oriented outwards relative to the antenna element 1, compared with the glass antenna 100 in which the opening portions of the folded portions on both the sides of the antenna element 1 are oriented inwards, the average gains are increased in any of the three types of bands. In addition, according to FIG. 12, the antenna gain in a high frequency band can be increased by causing the opening portions of the folded portions on both the sides of the antenna element 1 to be oriented inwards, while the antenna gain in a low to middle frequency band can be increased by causing the opening portions of the folded portions on both the sides of the antenna element 1 to be oriented outwards.

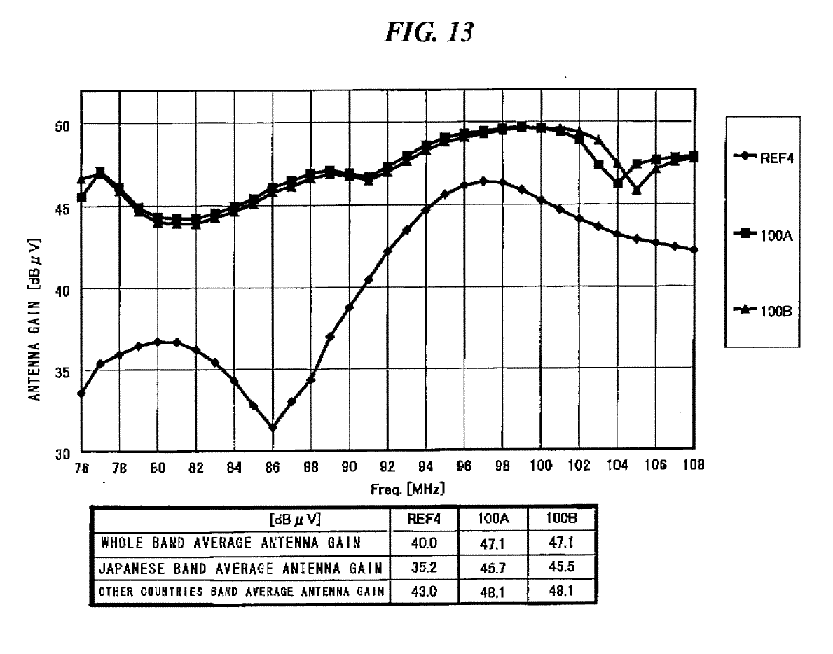

FIG. 13 is a frequency characteristic chart of antenna gains of glass antennas 100A, 100B and the glass antenna REF 4 which are substantially similar to each other in the length between A and B and the length between A and C. A difference between the glass antenna REF 4 and the glass antennas 100A, 100B resides in the existence of a folded portion. Namely, the difference resides in the length between B and D and the length between C and E. In addition, a difference between the glass antennas 100A and 100B resides in that the height in the vertical direction of the folded portion between B and D of the glass antenna 100B is decreased so as to increase the width of the folded portion in the left-right direction, and the height in the vertical direction of the folded portion between C and E is increased so as to decrease the width of the folded portion in the left-right direction, whereby the shape of the folded portions are changed without changing the lengths thereof. Because of this, there was caused a slight difference in length between A and B.

Dimensions of the respective portions of the glass antenna REF 4 (FIG. 10B) when the antenna gains in FIG. 13 were measured were as below:

Length between A and B: 1650 mm

Length between A and C: 1750 mm

Length between B and D: 590 mm

Length between C and E: 580 mm

Dimensions of the respective portions of the glass antenna 100A (FIG. 1) when the antenna gains in FIG. 13 were measured were as below:

Length between A and B: 1650 mm

Length between A and C: 1650 mm

Length between B and D: 930 mm

Length between C and E: 900 mm

Dimensions of the respective portions of the glass antenna 100B (FIG. 1) when the antenna gains in FIG. 13 were measured were as below:

Length between A and B: 1670 mm

Length between A and C: 1650 mm

Length between B and D: 930 mm

Length between C and E: 900 mm

According to FIG. 13, the antenna gains can be increased by addition of the folded portions. In addition, when comparing the glass antenna 100A with the glass antenna 100B, substantially the same tendencies are shown, and it is seen therefrom that the difference made by the shapes of the folded portions is small.

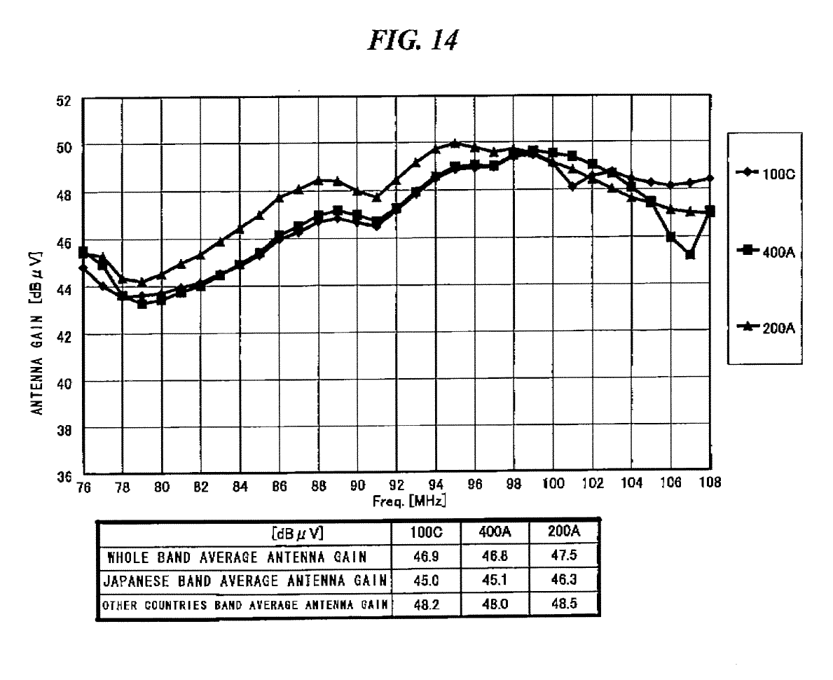

FIG. 14 is a frequency characteristic chart of antenna gains of glass antennas 100C, 400A and 200A which are equal to each other in length between B and D and length between C and E. A difference between the glass antennas 100C, 400A and 200A resides in orientation of opening portions of their folded portions. Namely, they are the length between A and B and a length between A and C.

Dimensions of the respective portions of the glass antenna 100C (FIG. 1) when the antenna gains in FIG. 14 were measured were as below:

Length between A and B: 1640 mm

Length between A and C: 1680 mm

Length between B and D: 900 mm

Length between C and E: 930 mm

Dimensions of the respective portions of the glass antenna 400A (FIG. 4) when the antenna gains in FIG. 14 were measured were as below:

Length between A and B: 2040 mm

Length between A and C: 1680 mm

Length between B and D: 900 mm

Length between C and E: 930 mm

Dimensions of the respective portions of the glass antenna 200A (FIG. 2) when the antenna gains in FIG. 14 were measured were as below:

Length between A and B: 2040 mm

Length between A and C: 2080 mm

Length between B and D: 900 mm

Length between C and E: 930 mm

According to FIG. 14, when comparing the glass antenna 100C and the glass antenna 400A which are different in length between A and B and are similar in length between A and C, there is found little difference in antenna gain in the Japanese band. On the other hand, when comparing the glass antenna 400A and the glass antenna 200A which are equal in length between A and B and are different in length between A and C, the antenna gain in the Japanese band of the glass antenna 200A is increased compared with the antenna gain of the glass antenna 400A. Consequently, it is seen that the length between A and C affects the antenna gain in the Japanese band. Consequently, by controlling the length between A and C, the antenna gain in the Japanese band can be controlled.

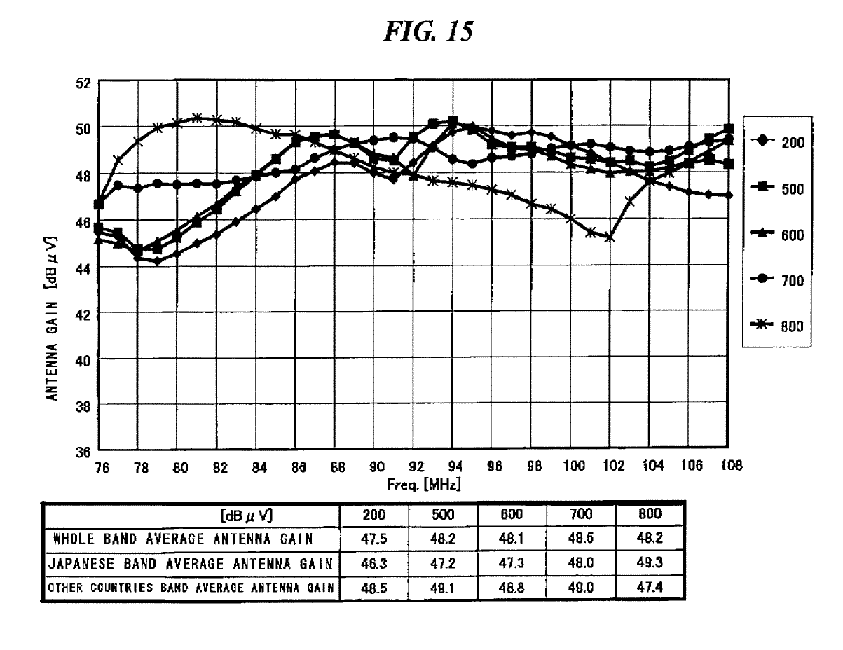

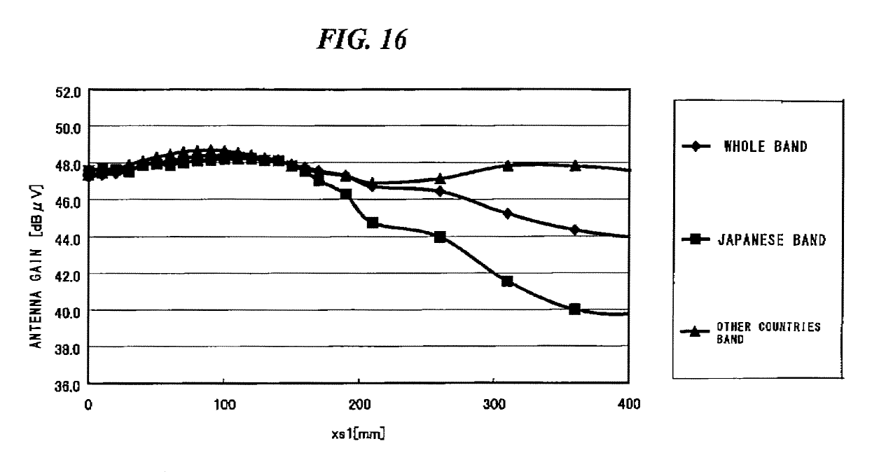

FIG. 15 is a frequency characteristic chart of antenna gains of the glass antennas 200, 500, 600, 700 and 800.

Dimensions of respective portions of the glass antenna 200 (FIG. 2) when the antenna gains shown in FIG. 15 were measured were as below:

Length between A and B: 1640 mm

Length between A and C: 1680 mm

Length between A and F: 1185 mm

Length between B and D: 900 mm

Length between C and E: 930 mm

Dimensions of respective portions of the glass antenna 500 (FIG. 5) when the antenna gains shown in FIG. 15 were measured were as below:

Length between A and B: 1650 mm

Length between A and C: 2150 mm

Length between A and F: 1185 mm

Length between B and D: 880 mm

Length between C and E: 1180 mm

Length between A and L: 1205 mm

Length between H and G: 145 mm

Dimensions of respective portions of the glass antenna 600 (FIG. 6) when the antenna gains shown in FIG. 15 were measured were as below:

Length between A and B: 1650 mm

Length between A and C: 2150 mm

Length between A and F: 1225 mm

Length between B and D: 680 mm

Length between C and E: 1180 mm

Length between A and L: 1205 mm

Length between H and G: 50 mm

Dimensions of respective portions of the glass antenna 700 (FIG. 7) when the antenna gains shown in FIG. 15 were measured were as below:

Length between A and B: 1560 mm

Length between A and C: 1980 mm

Length between A and F: 1185 mm

Length between B and D: 630 mm

Length between C and E: 1060 mm

Length between A and L: 1205 mm

Length between H and G: 185 mm

Dimensions of respective portions of the glass antenna 800 (FIG. 8) when the antenna gains shown in FIG. 15 were measured were as below:

Length between A and B: 1540 mm

Length between A and C: 2440 mm

Length between A and F: 830 mm

Length between B and D: 710 mm

Length between C and E: 1260 mm

Length between H and G: 363 mm

According to FIG. 15, with the glass antenna 500 in which the extension element 7 is provided, any of average gains in the three types of bands (whole FM band, Japanese FM band, Other countries FM band) is increased, compared with the glass antenna 200 in which no extension element 7 is provided.

In addition, according to FIG. 15, when the glass antenna 500 is compared with the glass antenna 600, it is seen that the high antenna gains can be secured whether the parallel extending portion extends parallel to the antenna element 2 above or below the antenna element 2.

Additionally, according to FIG. 15, with the glass antenna 700 in which the auxiliary antenna element 8 is added, compared with the other glass antennas, the antenna gain in the low area can be increased remarkably. Therefore, an average gain of the glass antenna 700 can be increased in any of the three types of bands.

In addition, according to FIG. 15, with the glass antenna 800, although the antenna gain in the other countries band is decreased, the antenna gain in the Japanese band can be increased, compared with the glass antenna 700. Therefore, an average antenna gain of the glass antenna 800 can be obtained that similar to the glass antenna 700 in the whole band.

FIG. 16 shows actually measured data of antenna gain for each band when the overlap length xsl is changed by controlling the length between H and G of the glass antenna 700. A value resulting from subtraction of 80 mm from the length between H and G corresponds to the overlap length xsl. Consequently, depending upon the length between H and G, the parallel extending portion exists to the left-hand side or below the antenna element 2. According to FIG. 16, in order to increase the average antenna gain in the whole frequency band of 76 to 108 MHz (the length xsl of the parallel extending portion is preferably made 200 mm or smaller. Further (the length xsl of the parallel extending portion is preferably controlled so as to be 40 mm or larger and 140 mm or smaller. In particular, the length of the parallel extending portion is preferably controlled so as to be 60 mm or larger and 120 mm or smaller.

Thus, according to the configuration of the invention, since the matching circuit is made unnecessary, the overall configuration to realize the glass antenna can be made small.

Consequently, with the antenna form such as the glass antennas 100 to 800, the glass antenna which can be used not only in Japan but also in other countries can be made smaller in size, and the antenna gain thereof can also be increased at the same time.

The invention is preferably used for the Japanese FM broadcast band (76 to 90 MHz), the US FM broadcast band (88 to 108 MHz), the television VHF band (90 to 108 MHz, 170 to 222 MHz), a vehicle keyless entry system (300 to 450 MHz), an 800 MHz band for automotive telephones (810 to 960 MHz), a 1.5 MHz band (1.429 to 1.501 MHz) for automotive telephones, a UHF band (300 MHz to 3 GHz), GPS (Global Positioning System), GPS signals of artificial satellites (1575.42 MHz) and VICS (trade name) (Vehicle Information and Communication System: 2.5 GHz).

What is claimed is:

1. A glass antenna provided with a window glass for a vehicle, comprising:
a feed part; and
an antenna conductor including a first element, a second element, a third element, a fourth element, a fifth element and a connection element, wherein:
the feed part is positioned to either a left-hand side or a right-hand side of the first element;
the first element extends in an upward or downward direction in a case that the window glass is attached to the vehicle and includes a first terminating portion which constitutes a termination of extension of the first element in a first direction which is either of the upward and downward directions and a second terminating portion which constitutes a termination of extension of the first element in a second direction which is an opposite direction to the first direction;
the second element extends from the first terminating portion in a third direction which is at right angles to the upward or downward direction and which is directed towards a side where the feed part is situated relative to the first element;
the third element extends from the first terminating portion in a fourth direction which is an opposite direction to the third direction;
the fourth element extends from the second element in the second direction;
the fifth element extends from the third element in the second direction;
the connection element extends to go around an element end in the second direction of the fourth element on a side in the second direction so as to connect the feed part with the second terminating portion; and
at least either of the fourth element and the fifth element includes a folded portion which extends to fold in the second direction.

2. The glass antenna according to claim 1, wherein:
both the fourth element and the fifth element extend to fold in the second direction;
a folded portion of the fourth element includes a first opening portion having at least one of a portion which is opened in the third direction and a portion which is opened in the fourth direction; and
a folded portion of the fifth element includes a second opening portion having at least one of a portion which is opened in the third direction and a portion which is opened in the fourth direction.

3. The glass antenna according to claim 1, wherein
a wavelength in the air of a central frequency of a desired broadcast frequency band is referred to as λ₀, a glass shortening coefficient of wavelength as k (where, k=0.64) and λ_{g} as λ_{g}=λ₀·k, a longest conductor path length of conductor path which connect the feed part and the termination of extension of the second element in a shortest way is 0.5λ_{g} or larger and 0.9λ_{g} or smaller.

4. The glass antenna according to claim 1, wherein
a longest conductor path length of conductor path which connect the feed part and the termination of extension of the second element in a shortest way is 1043 mm or larger and 1877 mm or smaller.

5. The glass antenna according to claim 1, wherein
a wavelength in the air of a central frequency of a desired broadcast frequency band is referred to as λ₀, a glass shortening coefficient of wavelength as k (where, k=0.64) and λ_{g} as λ_{g}=λ₀·k, a conductor length of the fourth element is 0.20λ_{g} or larger and 0.60λ_{g} or smaller.

6. The glass antenna according to claim 1, wherein
a conductor length of the fourth element is 417 mm or larger and 1251 mm or smaller.

7. The glass antenna according to claim 1, wherein
a wavelength in the air of a central frequency of a desired broadcast frequency band is referred to as λ₀, a glass shortening coefficient of wavelength as k (where, k=0.64) and λ_{g} as λ_{g}=λ₀·k, a conductor length of the fifth element is 0.20λ_{g} or larger and 0.60λ_{g} or smaller.

8. The glass antenna according to claim 1, wherein
a conductor length of the fifth element is 417 mm or larger and 1251 mm or smaller.

9. The glass antenna according to claim 1, wherein
when assuming that a wavelength in the air of a central frequency of a desired broadcast frequency band is referred to as λ₀, a glass shortening coefficient of wavelength as k (where, k=0.64) and λ_{g} as λ_{g}=λ₀·k, a longest conductor path length of conductor path which connect the feed part and a termination of extension of the fifth element in a shortest way is 0.65λ_{g} or larger and 1.20λ_{g} or smaller.

10. The glass antenna according to claim 1, wherein
a longest conductor path length of conductor path which connect the feed part and a termination of extension of the fifth element in a shortest way is 1355 mm or larger and 2500 mm or smaller.

11. The glass antenna according to claim 1, wherein:
the antenna conductor includes an extension element which extends from the feed part; and
the extension element includes a parallel extending portion which extends parallel to the second element.

12. The glass antenna according to claim 11, wherein
a conductor length of the parallel extending portion is 40 mm or larger and 140 mm or smaller.

13. The glass antenna according to claim 2, wherein:
the antenna conductor includes an extension element which extends from the feed part; and
the extension element includes a parallel extending portion which extends parallel to the second element.

14. The glass antenna according to claim 13, wherein
a conductor length of the parallel extending portion is 40 mm or larger and 140 mm or smaller.

15. A window glass for a vehicle, comprising
the glass antenna according to claim 1.

16. A window glass for a vehicle, comprising
the glass antenna according to claim 2.
